(19) United States
(12) Patent Application Publication
(10) Pub. No.: US 2007/0251340 A1
(43) Pub. Date: Nov. 1, 2007

(54) Escape Wheel

(76) Inventor: Willy Meier, Fontaines (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/573,029

(22) PCT Filed: Sep. 8, 2004
(86) PCT No.: PCT/CH04/00562

§ 371 Date: Mar. 15, 2007

(30) Foreign Application Priority Data
Sep. 22, 2003 (EP) 03405690.3

(51) Int. Cl. G04B 15/14

(52) U.S. Cl. 74/1.5

(57) ABSTRACT

An escape wheel is disclosed having a direction of rotation, defining an upstream direction and a downstream direction, that may be configured to be used in an escape mechanism. The wheel may include a hub, a felly mounted to the hub, and at least one tooth disposed radially on the felly. Each tooth may include a stem that terminates in a finger. The finger may include a first part having a first thickness on the side of the felly, and a second part having a smaller second thickness disposed on the side of an end of the finger. The boundary between the first and second parts may define a threshold that is configured to form an oil container together with the face of the second part adjacent thereto.

The present invention relates to mechanical horology. It is more particularly concerned with a wheel of an escapement mechanism of the type that receives energy from a barrel spring and drives a balance by means of a lever in which pallets are set. The escape wheel is provided with teeth constructed so as to engage with the pallets of the lever.

The interaction between the pallets and the teeth of the escape wheel produces friction. Without lubrication of the regions of contact between these parts, they wear down prematurely. The efficiency of the escapement is also noticeably affected by this.

The lubrication problem is one that is particularly difficult to solve. Specifically, the oil used must be stable, and in particular must resist oxidation and not be affected by changes of temperature, and, above all, must stay in the contact region without spreading over the wheel. This is because the forces involved are very small, which means that the oil must be fluid. Since the shocks produced by the impulses are large, there is a significant risk of the oil dispersing and spreading across the wheel, and even getting into the gearing, which is highly prejudicial.

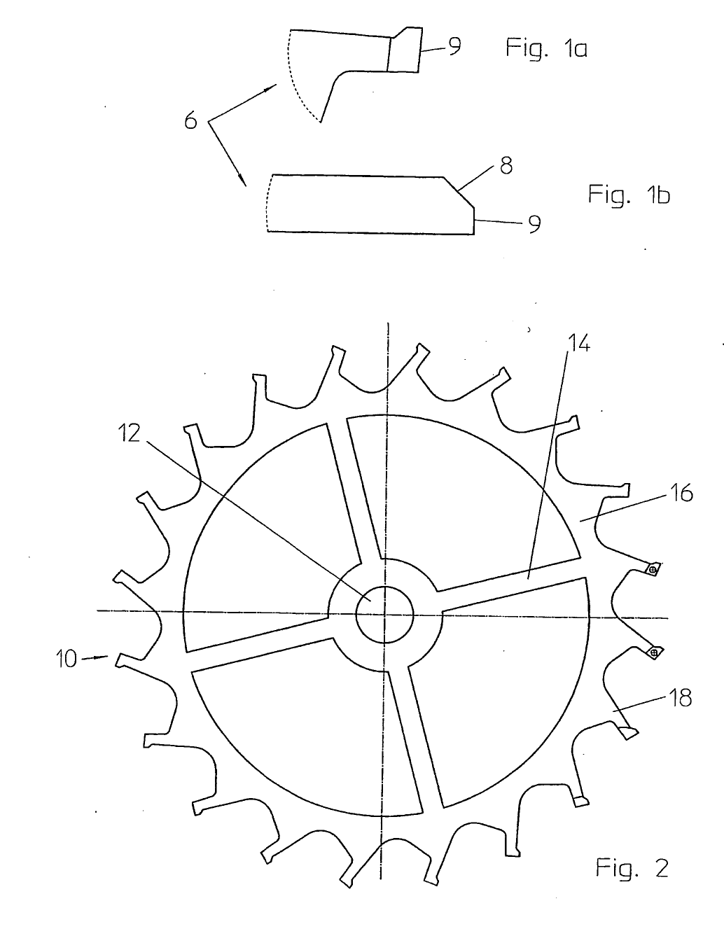

One of the methods usually adopted to solve this problem is presented in FIGS. 1a and 1b. The teeth 6 of the escape wheel end in a beveled plane 8 forming an obtuse angle with the plane of the wheel. Oil deposited on the plane 8 adheres to this plane and, because of surface tension, spreads onto the end 9 of the tooth which defines the region of contact with the pallets of the lever.

It is an object of the present invention to improve the containment of the lubricant in the region of contact between the escape wheel and the pallets of the lever, and particularly to simplify the construction of the wheel.

More specifically, the invention relates to an escape wheel whose direction of rotation defines an upstream direction and a downstream direction, said wheel being designed to form part of an escapement mechanism and being formed by: a hub; a felly connected to the hub; and teeth arranged radially on said felly, said teeth having a root ending in a finger.

According to the invention, the finger comprises a first part of thickness E situated towards the felly and a second part of lesser thickness e situated towards the end of the finger, the boundary between these two parts defining a threshold which, with the adjacent face of the second part, forms an oil holder.

Advantageously, the thickness of the second part is approximately equal to one-half of that of the first part.

The distance between the threshold and the end of the tooth is approximately equal to the thickness of the wheel.

The wheel also has one or other of the following features:
the wall of the oil holder formed by said threshold is concave;
the wall of the oil holder has interruptions;
the second part comprises a cavity formed in its thickness; and
the second part carries a projection extending in the thickness of the wheel.

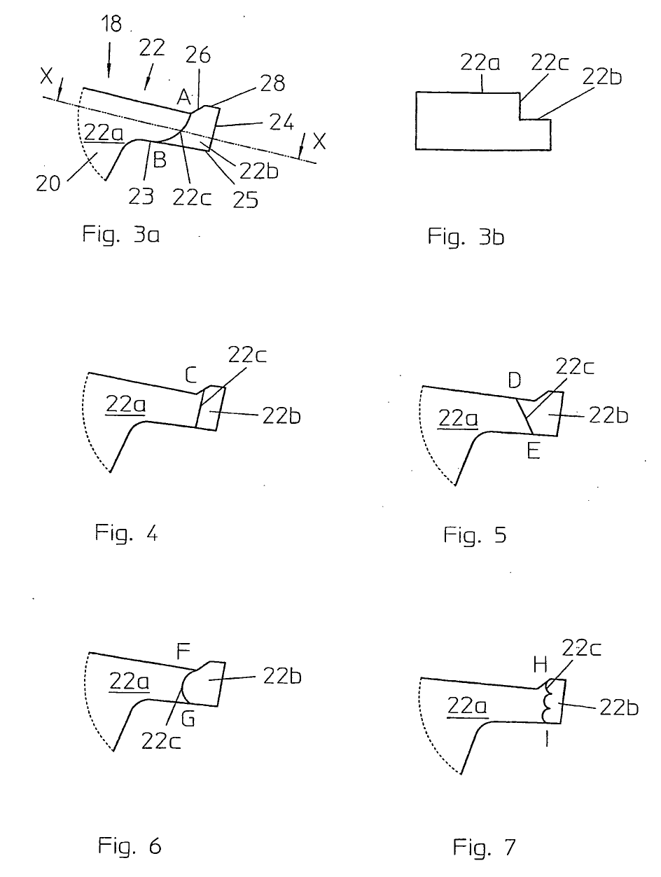

Other features of the invention will become clearer in the light of the following description, which refers to the accompanying drawing in which:
FIG. 2 is a top view of an escape wheel; and
FIGS. 3a, 3b, 4, 5, 6 and 7 are enlarged views of teeth of the escape wheel in different embodiments of the invention.

FIG. 2 shows an escape wheel 10 formed by: a hub 12; four coplanar equal-length arms 14 arranged orthogonally on the hub 12; a felly 16 supported by the arms 14; and, situated around the periphery of the wheel, continuous with the felly 16, teeth 18, of which there are typically twenty. The dimensions of the wheel vary depending on the caliber in which it is used.

The escape wheel illustrated in FIG. 2 operates by turning clockwise. This direction of rotation defines, for each tooth, an upstream side oriented in the forward direction of the wheel, and a downstream side.

In a Swiss escapement mechanism, which is much the most widely used, the teeth 18 have a triangular root 20 (FIG. 3a) whose end is truncated and replaced by a finger 22 formed by a base 23 and a nose 24. More precisely, the nose 24 has, on the upstream side, a part 25 in line with the edge of the base 23 and, on the downstream side, a bevel 26 that is continued by a straight part 28 parallel to the part 25.

According to the invention, and as shown in FIG. 3b, the finger 22 comprises a first part 22a situated towards and of the same thickness as the felly 16, and a second part 22b of lesser thickness situated towards the end of the finger. The boundary between these two parts defines a threshold 22c. Typically, the thickness of the part 22a is 0.15 mm, and that of the part 22b is 0.08 mm.

The second part 22b and the threshold 22c form a limited space that acts as an oil holder. In this way the space intended to retain the oil is well defined. The amount of lubricant available can thus be increased without the risk of contamination. Moreover, this space retains the lubricant during the shock of the escape wheel against the pallet, at the end of the impulse.

In a first variant shown in FIG. 3, the threshold 22c forms a concave wall which connects, in a quarter-circle arc, a point A situated on the downstream side, at the junction of the base 23 with the bevel 26, and a point B situated on the upstream side of the base 23.

In a second variant shown in FIG. 4, the threshold 22c is parallel to the end of the tooth 18 and passes through a point C situated on the bevel 26.

In a third variant (FIG. 5), the threshold 22c connects a point D situated on the upstream side on the base 23, and a point E situated on the downstream side on a line approximately tangent to a circle passing through the center of the wheel.

FIG. 6 shows a fourth variant in which the threshold 22c defines a concave space that connects a point F situated at the junction of the base 23 with the bevel 26, and a point G situated at the same distance from the end of the finger 22 as the point F.

Lastly, FIG. 7 shows yet another variant of the invention. The threshold 22c connects a point H situated at the junction of the bevel 26 with the straight part 28 that ends the nose 24, and a point I situated at the same distance from the end of the finger 22 as the point H. Between these two points the threshold 22c forms three concave waves and divides the width of the finger 22 into three identical recesses. The wall formed by the threshold 22c thus has interruptions that further improve oil retention.

To lubricate the escapement, a drop of oil is usually placed on the impulse plane of the entry pallet of the lever, the lever being stopped. When the escapement begins to function, part of the oil is transferred from the pallet to each of the teeth of the wheel, and from here to the exit pallet. The oil is therefore distributed very quickly and evenly between the different parts of the escapement.

The lubricant deposited on the lower part 22b of the finger 22 has a surface tension such that it can spread onto the end of the nose 24, particularly onto the region of contact with the lever pallets, whereas the height and shape of the threshold 22c prevent it from spreading onto the escape wheel and through the watch movement. The lower part 22a and the threshold 22c thus form an oil holder as an integral part of each of the teeth of the wheel 10.

To further increase the surface area of lubricant retention, the thinner part 22b may also include a cavity or a projection such as a post or pin.

The examples given above do not of course limit the scope of the invention and the threshold 22c may take many other forms.

Such an escape wheel can be made very simply, reliably and accurately, for example by electroforming.

1. An escape wheel configured to form part of an escapement mechanism, the escape wheel comprising:
a hub;
a felly connected to the hub; and
at least one tooth arranged radially on the felly, the tooth having a root ending in a finger;
wherein the finger comprises:
a first part having a first thickness situated towards the felly, and a second part having a lesser second thickness situated towards an end of the finger, the boundary between the first and second parts defining a threshold that, with an adjacent face of the second part, is configured to form an oil holder.

2. The wheel of claim 1, wherein the second thickness is approximately equal to one-half of the first thickness.

3. The wheel of claim 1, wherein the distance between the threshold and the end of the tooth is approximately equal to the thickness of the wheel.

4. The wheel of claim 1, wherein the wall of the oil holder formed by the threshold is concave.

5. The wheel of claim 4, wherein the wall has interruptions.

6. The wheel of claim 1, wherein the second part further includes a cavity formed in its thickness.

7. The wheel of claim 1, wherein the second part carries a projection extending in the thickness of the wheel.
